(19) United States
(12) Patent Application Publication
(10) Pub. No.: US 2005/0135382 A1
(43) Pub. Date: Jun. 23, 2005

(54) Connection management system

(76) Inventor: Bert William Ross, Lilburn, GA (US)

Correspondence Address: THOMAS, KAYDEN, HORSTEMEYER & RISLEY, LLP/;BELLSOUTH I.P. CORP, 100 GALLERIA PARKWAY, SUITE 1750, ATLANTA, GA, 30339, US

(21) Appl. No.: 10/741,974

(22) Filed: Dec. 19, 2003

(51) Int. Cl. H04L 12/28

(52) U.S. Cl. 370/395.52

(57) ABSTRACT

A modem system is provided. The system typically includes a processor, a memory, and an input/output interface. The processor typically executes code, while the memory is coupled to the processor, and stores a connection management program. The input/output interface is coupled to the processor, and receives data from and sends data to a remote server, and provides data to and receives data from a local computer. The input/output interface further provides an interface for the connection management program to the local computer. Other systems and methods are also provided.

### TECHNICAL FIELD

The present disclosure relates generally to communications, and more particularly to troubleshooting network connectivity.

### DESCRIPTION OF THE RELATED ART

The popularity of the worldwide-web has led to an increasing demand for increased data rates from consumers. This increasing demand has led to the development of broadband solutions for the consumer market. These broadband solutions include integrated service digital network (ISDN), digital subscriber line (DSL) and cable modems. However, increased bandwidths and data rates result in increased complexity for consumers to manage when connecting to the internet through an internet service provider (ISP).

One of the first solutions to solving these problems was to send technicians to install DSL modems and ISDN lines at each customer's premises. Further, the services are often subject to some outages, for which a technician could be required. However, using a technician is costly for the service provider, and the cost is ultimately passed on to the consumers. Thus, to make DSL more available to consumers, through lower prices, service providers developed a software solution to allow consumers to connect themselves and troubleshoot their connections to the service provider. These software solutions are efficient in that they allow the customers to troubleshoot their own DSL modems without waiting a day or more for a technician to repair service. However, the software typically consumes a large amount of system resources. Moreover, the software can conflict with customers' systems and provide problems for the user apart from the DSL modem. Therefore, there is a need for systems and methods that address these and/or other perceived shortcomings of the prior art.

### SUMMARY OF THE DISCLOSURE

One embodiment, among others, of the present disclosure provides for a modem system. A representative system, among others, includes a processor, a memory and an input/output interface. The processor typically executes computer executable code installed on the modem in the memory. The memory is typically coupled to the processor and stores a connection management program. The input/output interface is coupled to the processor and receives data from, and sends data to, a remote server and provides data to, and receives data from, a local computer. The input/output interface further provides an interface for the connection management program to the computer.

A representative method, among others, includes the following steps: receiving a request from a user to initiate internet data service; providing the user with a modem for internet data service, the modem comprising a connection management program operable to assist the user in setting up the modem and internet data service; and, supplying internet data service to the user.

### BRIEF DESCRIPTION OF THE FIGURES

The disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a block diagram of an embodiment, among others, of a typical DSL modem connection to the internet through an ISP.

FIG. 2 is a block diagram of an embodiment, among others, of the DSL modem shown in FIG. 1.

FIG. 3 is a screen shot of an embodiment, among others, of a positive status screen representation the connection manager of FIG. 2.

FIG. 4 is a screen shot of an embodiment, among others, of a negative status screen representation of the connection manager of FIG. 2.

FIG. 5 is a screen shot of an embodiment, among others, of a server details screen representation of the connection manager of FIG. 2.

FIG. 6 is a screen shot of an embodiment, among others, of a server details report screen representation of the connection manager of FIG. 2.

FIG. 7 is a screen shot of an embodiment, among others, of a repair center screen representation of the connection manager of FIG. 2.

FIG. 8 is a screen shot of an embodiment, among others, of a computer details screen representation of the connection manager of FIG. 2.

FIG. 9 is a screen shot of an embodiment, among others, of a computer details report screen representation of the connection manager of FIG. 2.

FIG. 10 is a screen shot of an embodiment, among others, of an advanced options screen representation of the connection manager of FIG. 2.

FIG. 11 is a screen shot of an embodiment, among others, of a computer verifier screen representation of the connection manager of FIG. 2.

FIG. 12 is a screen shot of an embodiment, among others, of a connection test screen representation of the connection manager of FIG. 2.

FIG. 13 is a screen shot of an embodiment, among others, of a “FastAccess” details screen representation of the connection manager of FIG. 2.

FIG. 14 is a screen shot of an embodiment, among others, of a “FastAccess” details report screen representation of the connection manager of FIG. 2.

FIG. 15 is a screen shot of an embodiment, among others, of an internet details screen representation of the connection manager of FIG. 2.

FIG. 16 is a screen shot of an embodiment, among others, of an internet details report screen representation of the connection manager of FIG. 2.

### DETAILED DESCRIPTION OF THE PREFERRED EMBODIMENTS

Embodiments of the disclosure now will be described more fully with reference to the accompanying drawings. The disclosure may, however, be embodied in many different forms and should not be construed as limited to the embodiments set forth herein; rather, these embodiments are intended to convey the scope of the disclosure to those skilled in the art. Furthermore, all “examples” given herein are intended to be non-limiting.

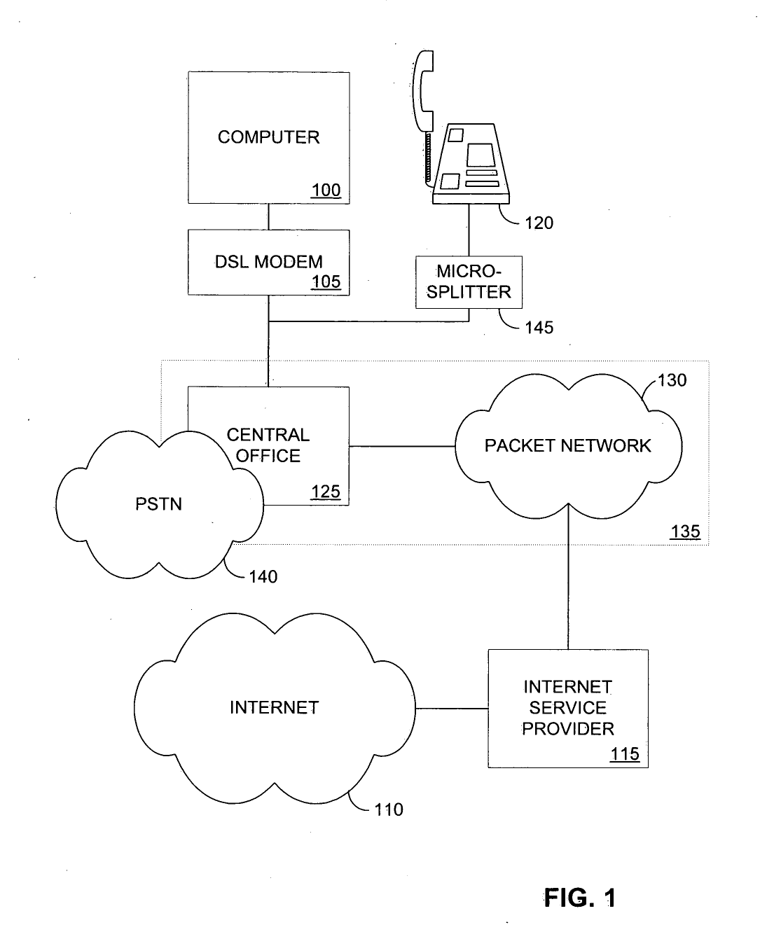

Referring now to FIG. 1, shown is a block diagram of an embodiment, among others, of a typical computer 100 using a DSL modem 105 to connect to the internet 110 through an ISP 115. A consumer user with a DSL subscription typically connects to the internet 110 using the same twisted pair cable that is used for telephone wiring. Thus, the DSL modem 105 and the telephone 120 communicate over the same communication medium. Typically this is achieved by reserving the 0-4 kHz range for plain-old telephone service (POTS) communications, and using the range of frequencies above 4 kHz for data communication. Moreover, many consumers use an asymmetric DSL (ADSL) service that provides more downstream bandwidth than upstream bandwidth. Thus, the frequencies above 4 kHz are typically split between upstream data communication and downstream data communication. However, one skilled in the art should immediately recognize that there are numerous variations to the basic DSL service provided to most consumers. These can include, among many others, adding another twisted pair to increase DSL data rates such as in high-bit rate DSL (HDSL), adding more voice channels in frequency ranges above 4 kHz, or increasing the size of the transmitted data constellation.

The DSL modem 105 typically generates a signal that is transmitted to a central office (CO) 125, at which point the signal is typically filtered to remove the POTS frequency band signal using a DSL access multiplexer (DSLAM). The (CO) typically uses an ATM or frame relay switch to transfer the data signal to a packet network 130. The packet network 130 typically communicates the data signal to an ISP 115. Moreover, for legal reasons, the ISP 115 is typically under a separate entity than the local exchange carrier (LEC).

Furthermore, after separating the voice signal from the data signal, the DSLAM sends the voice signal to a circuit switch where it is passed through the PSTN 140 to its ultimate destination. One skilled in the art should recognize that the term PSTN 140 may embody part of the CO functions as they pertain to switching telephone calls. Thus, the PSTN 140 is drawn to partly encompass the CO 125 so as to show that the PSTN 140 includes some of the CO hardware. However, one skilled in the art should recognize that the vast majority of the PSTN 140 exists outside of the CO 125 and outside of the LEC 135.

It should also be understood that in consumer applications the DSL modem 105 typically includes a high pass filter to filter out the 0-4 kHz frequencies, and the phone is typically connected to a micro-splitter 145, which filters out the high frequencies that are reserved for data transmission. However, one skilled in the art should recognize that a single splitter is installed to separate the data and voice signals such that a the DSL modem does not have a high pass filter. The single splitter configuration is typically used in higher end systems such as would be used by small businesses or local area networks (LANs).

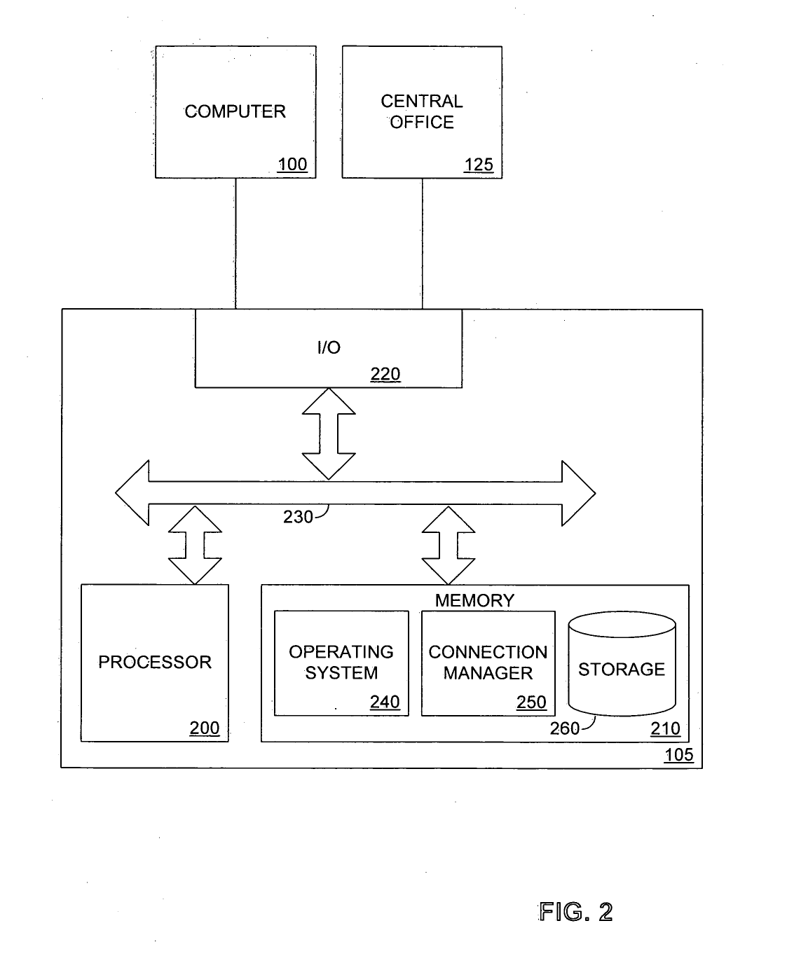

Referring now to FIG. 2, shown is a block diagram of an embodiment, among others, of the DSL modem 105 shown in FIG. 1. Generally, in terms of hardware architecture, as shown in FIG. 2, the DSL modem 105 includes a processor 200, memory 210, and one or more input and/or output (I/O) devices 220 (or peripherals) that are communicatively coupled via a local interface 230. The local interface 230 is, for example but not limited to, one or more buses or other wired or wireless connections, as is known in the art. The local interface 230 typically has additional elements, which are omitted for simplicity, such as controllers, buffers (caches), drivers, repeaters, and receivers, to enable communications. Further, the local interface includes address, control, and/or data connections to enable appropriate communications among the aforementioned components.

The processor 200 is a hardware device for executing software, particularly that stored in memory 210. The processor 200 is typically any custom made or commercially available processor, a central processing unit (CPU), an auxiliary processor among several processors associated with the DSL modem 210, a semiconductor based microprocessor (in the form of a microchip or chip set), a macroprocessor, or generally any device for executing software instructions.

The memory 210 includes any one or combination of volatile memory elements (e.g., random access memory (RAM, such as DRAM, SRAM, SDRAM, etc.)) and nonvolatile memory elements (e.g., ROM, hard drive, tape, CDROM, etc.). Moreover, the memory 210 may incorporate electronic, magnetic, optical, and/or other types of storage media. Note that the memory 210 in some implementations have a distributed architecture, where various components are situated remote from one another, but can be accessed by the processor 210.

The software in memory 210 includes one or more separate programs 240, 250, each of which comprises an ordered listing of executable instructions for implementing logical functions. In the example of FIG. 2, the software in the memory 210 includes the connection manager 250 and a suitable operating system (O/S) 240. The operating system 240 essentially controls the execution of other computer programs, such as the connection manager 250, and provides scheduling, input-output control, memory management, and communication control and related services.

The connection manager 250 are source programs, executable program (object code), script, or any other entity comprising a set of instructions to be performed. When a source program, then the program needs to be translated via a compiler, assembler, interpreter, or the like, which may or may not be included within the memory 210, so as to operate properly in connection with the O/S 250. Furthermore, the connection manager 250 is typically written as (a) an object oriented programming language, which has classes of data and methods, or (b) a procedure programming language, which has routines, subroutines, and/or functions, for example but not limited to, C, C++, Pascal, Basic, Fortran, Cobol, Perl, Java, and Ada.

The I/O devices 220 typically includes input devices, for example but not limited to, an RJ-45 or RJ-11 jack for sending/receiving a DSL signal to/from a CO 125 and an ethernet or universal serial bus (USB) jack for sending/receiving the DSL signal to/from the computer 100. Finally, the I/O devices 220 may further include devices that communicate both inputs and outputs, for instance but not limited to, a radio frequency (RF) or other transceiver, a telephonic interface, a bridge, a router, etc.

When the DSL modem 105 is in operation, the processor 200 is configured to execute software stored within the memory 210, to communicate data to and from the memory 210, and to generally control operations of the DSL modem 105 pursuant to the software. The connection manager 250 and the O/S 240, in whole or in part, but typically the latter, are read by the processor 200, perhaps buffered within the processor 200, and then executed.

When the connection manager 250 is implemented in software, as is shown in FIG. 2, it should be noted that the connection manager 250 is stored on any computer readable medium for use by or in connection with any computer related system or method. In the context of this document, a computer readable medium is an electronic, magnetic, optical, or other physical device or means that contains or store a computer program for use by or in connection with a computer related system or method. The connection manager 250 in various implementations is embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” is any means that can store, communicate, propagate, or transport the program for use by or in connection with the instruction execution system, apparatus, or device. The computer readable medium is typically, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium in some implementations is even paper or another suitable medium upon which the program is printed, as the program can be electronically captured, via for instance optical scanning of the paper or other medium, then compiled, interpreted or otherwise processed in a suitable manner if necessary, and then stored in a computer memory.

The connection manager 250 shown operates to diagnose problems with the user's connection and/or hardware, and network problems as known in the art. The connection manager 250 stored and executed on the DSL modem 105 saves system resources for the user's computer. Moreover, the connection manager stored and executed on the modem reduces problems with compatibility between the software and the computer 105. Further, the connection manager stored and executed on the modem provides remote diagnostics for providing technical assistance to the user. The connection manager stored and executed on the DSL modem 105 also facilitates software upgrades by the service provider without the fear of corrupting a user's data or creating software/hardware conflicts on the user's computer.

The connection manager 250 in some implementations is programmed to provide the computer 100 with a video stream diagnostic screen for the DSL modem 105. The video stream is displayed, in one embodiment, among others, on the computer 100 using an internet browser. In particular the video stream typically includes information about data rate, server problems, network problems, modem problems, etc. Under each category the programmer typically defines subcategories for failures. For example, among others, the server category would include subcategories, among others, of web server, newsgroup server, and e-mail server. A failure for one of these subcategories typically leads to a failure for the server category.

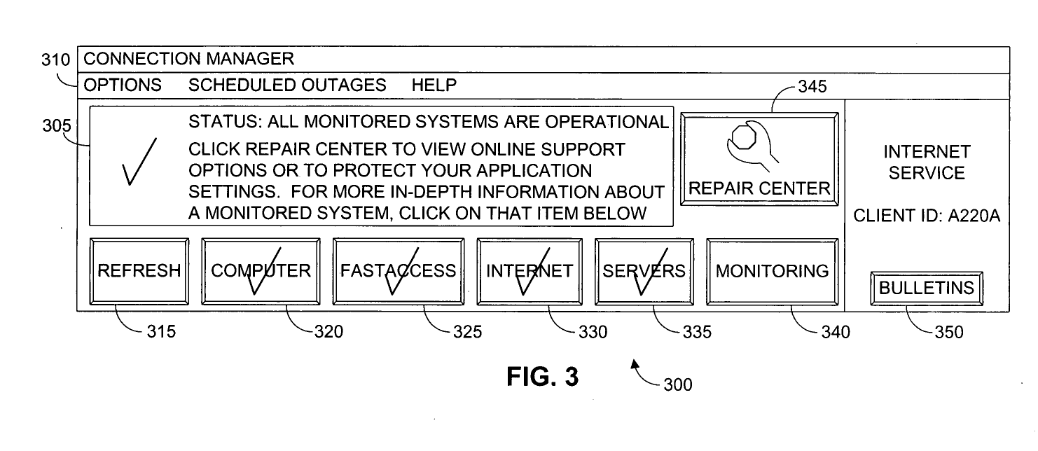

Referring now to FIG. 3, shown is a sample screen shot of an embodiment, among others, of an opening screen representation 300 of the communications manager of FIG. 2. Typically each of the subsequent screen representations include at least the contents of the opening screen representation 300. In particular, the opening screen representation includes an overall status indicator 305. The opening status indicator 305 is typically either positive or negative, and includes a short description about the status. The connection manager typically includes a menu representation 310 which enables a user to view options, scheduled outages, and/or seek help with using the connection manager.

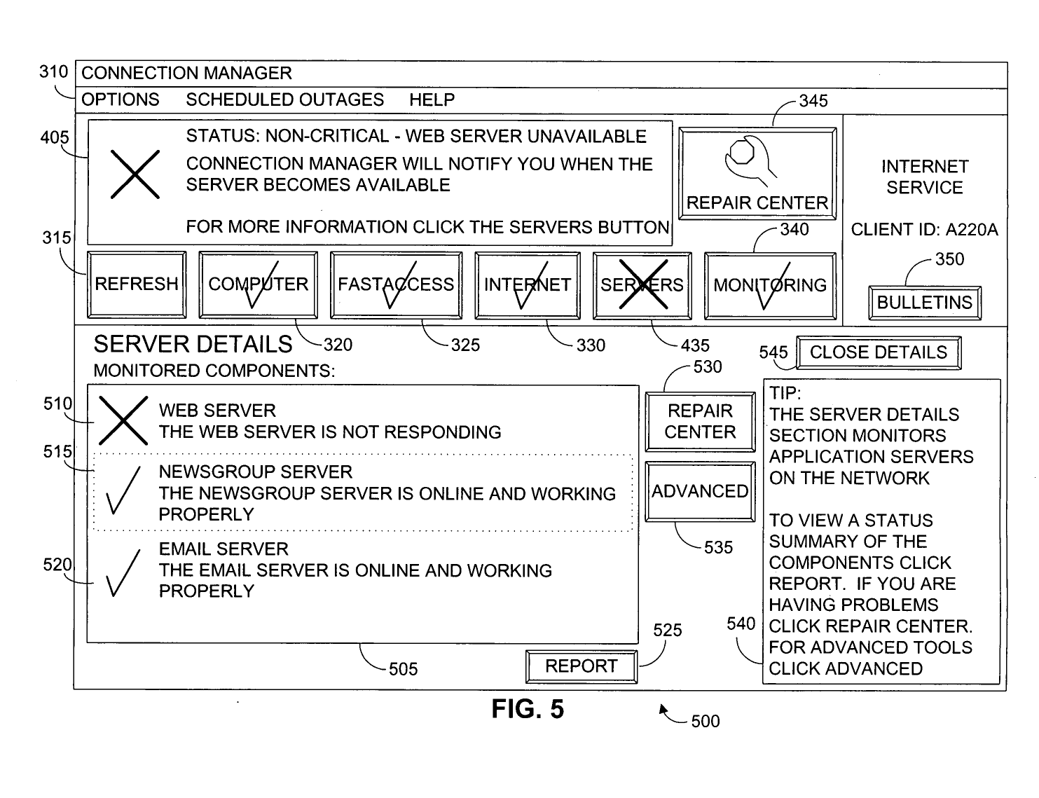

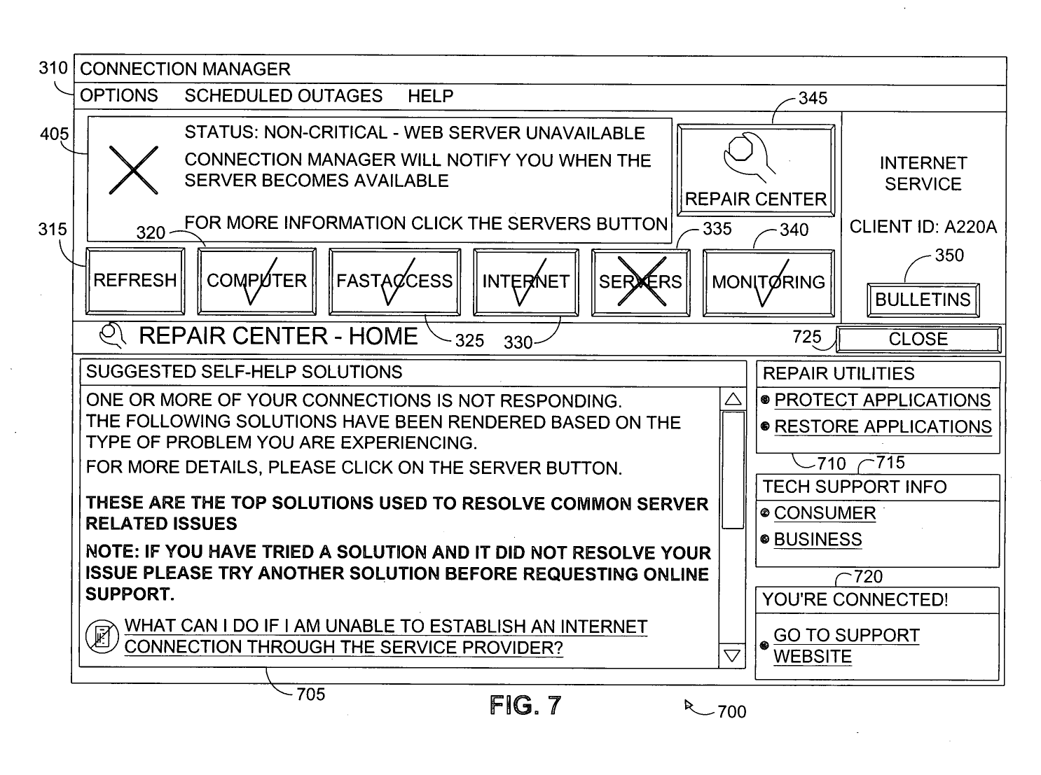

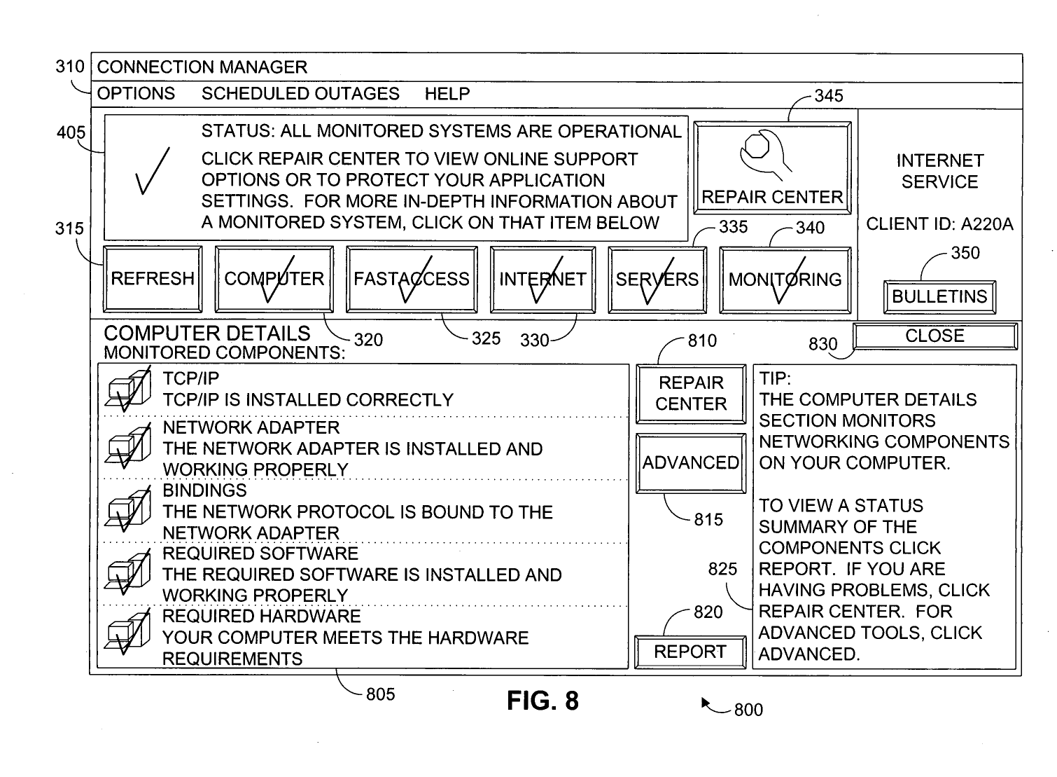

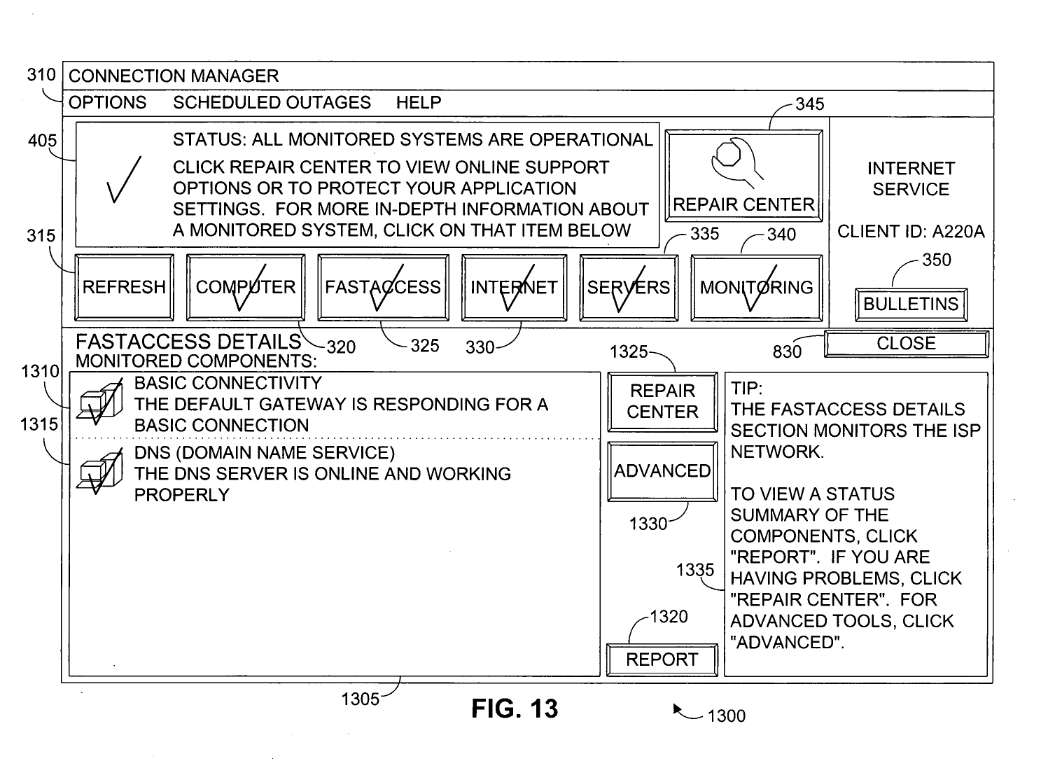

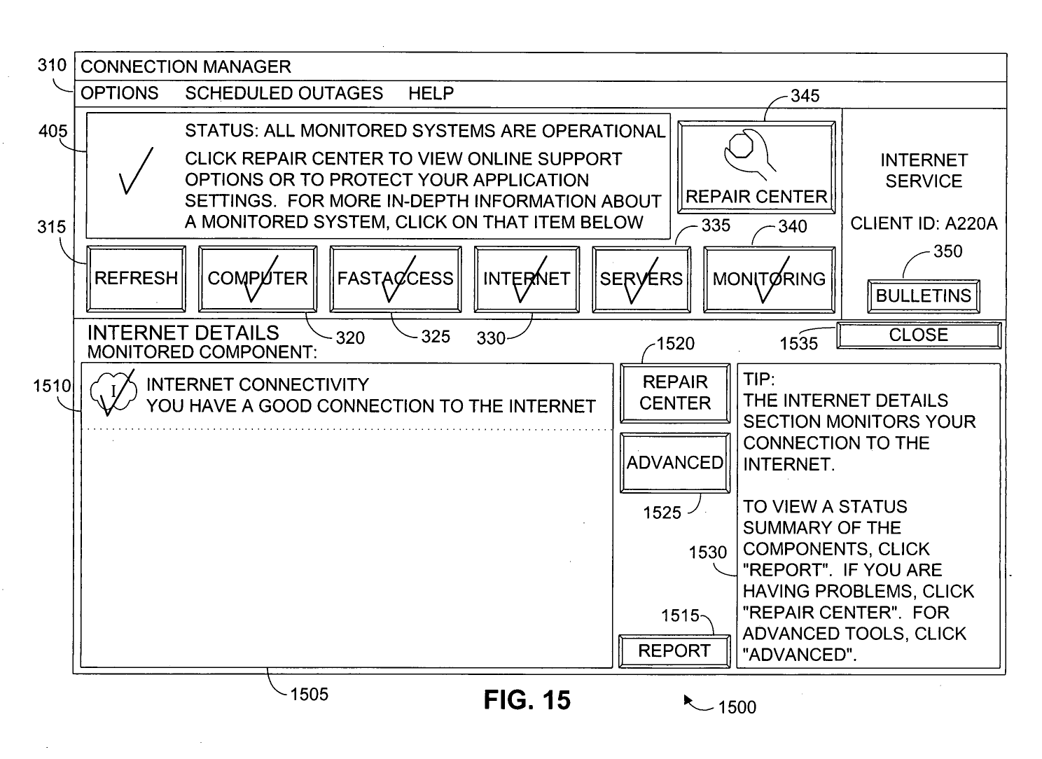

The connection manager 250 also typically includes a plurality of button representations 315-350. The button representations 315-350 can typically include, among others: a “Refresh” button representation 315; a “Computer” button representation 320; a “FastAccess” button representation 325; an “Internet” button representation 330; a “Servers” button representation 335; a “Monitoring” button representation 340; a “Repair” button representation 345; and, a “Bulletin” button representation 350. The “Refresh” button representation 315, when selected, typically instructs the connection manager to perform a variety of tests to determine if the connection is running. The “Computer” button representation 320, when selected, typically requests a computer diagnostics screen representation as shown in FIG. 8. The “FastAccess” button representation 325, when selected, typically requests a connection diagnostics screen representation as shown in FIG. 13. The “Internet” button representation 330, when selected, typically requests an internet diagnostics screen representation as shown in FIG. 15. The “Servers” button representation 335, when selected, typically requests a server diagnostic screen representation as shown in FIG. 5. The “Monitoring” button representation 340 typically shows the user whether the system is being monitored. The “Repair” button representation 345, when selected, typically enables the user to attempt to diagnose and perform repairs as shown in FIG. 7. The “Bulletin” button representation 350 typically enables a user to view any postings made by the service provider related to the service.

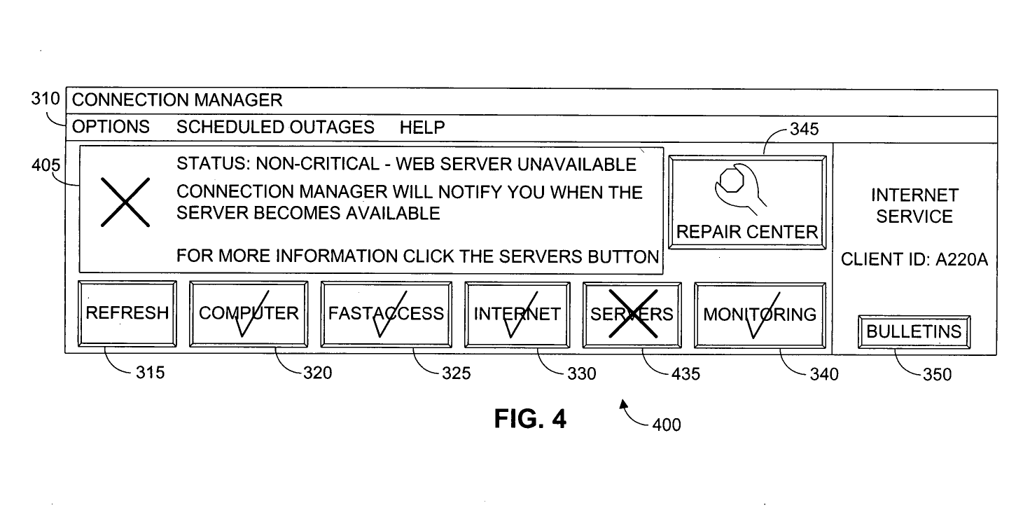

Referring now to FIG. 4, shown is a sample screen shot of an embodiment, among others, of an opening screen representation when a problem exists. Typically this screen representation 400 is similar to the screen shot of FIG. 3. However, the status representation 405 on the screen representation 400 includes a negative status indication denoting a problem. The status representation 405 also gives a synopsis of the problem. In this example embodiment, among others, the problem is with a web server at the ISP. Moreover, the “Servers” button representation 435 includes a problem indication.

Referring now to FIG. 5, shown is a sample screen shot of an embodiment, among others, of a server details screen representation 500 of the connection manager 250. In particular the screen representation 500 typically includes a server details status representation 505. The status representation 505 typically includes a list of items 510-520, which the connection manager 250 is configured to track. In particular, the connection manager 250 is typically operable to track a web server indicated by the web server status representation 510, a newsgroup server indicated by the newsgroup server status representation 515 and an e-mail server indicated by the e-mail server status representation 520.

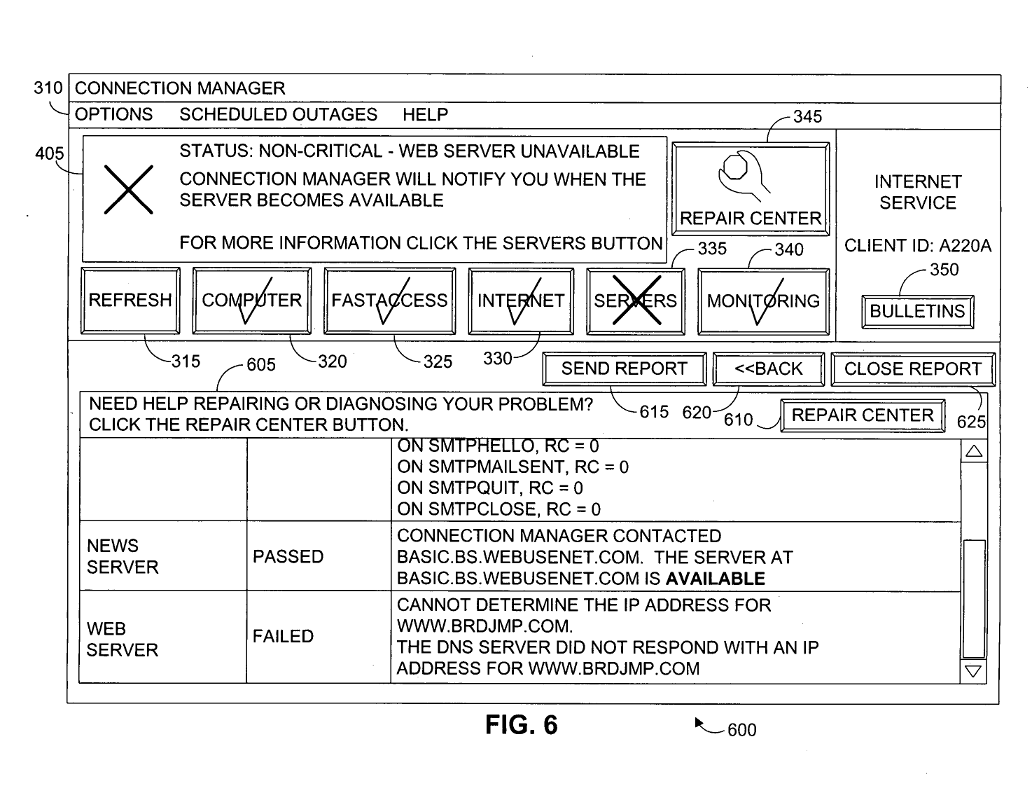

The user typically generates a report on the problem by selecting the “Report” button representation 525. The report includes a number of subcomponents which will help the user to determine a cause for the problem. A sample report is shown with respect to FIG. 6. Typically the report will include details about the results of various attempts to contact machines associated with the specified activity (e.g. e-mail).

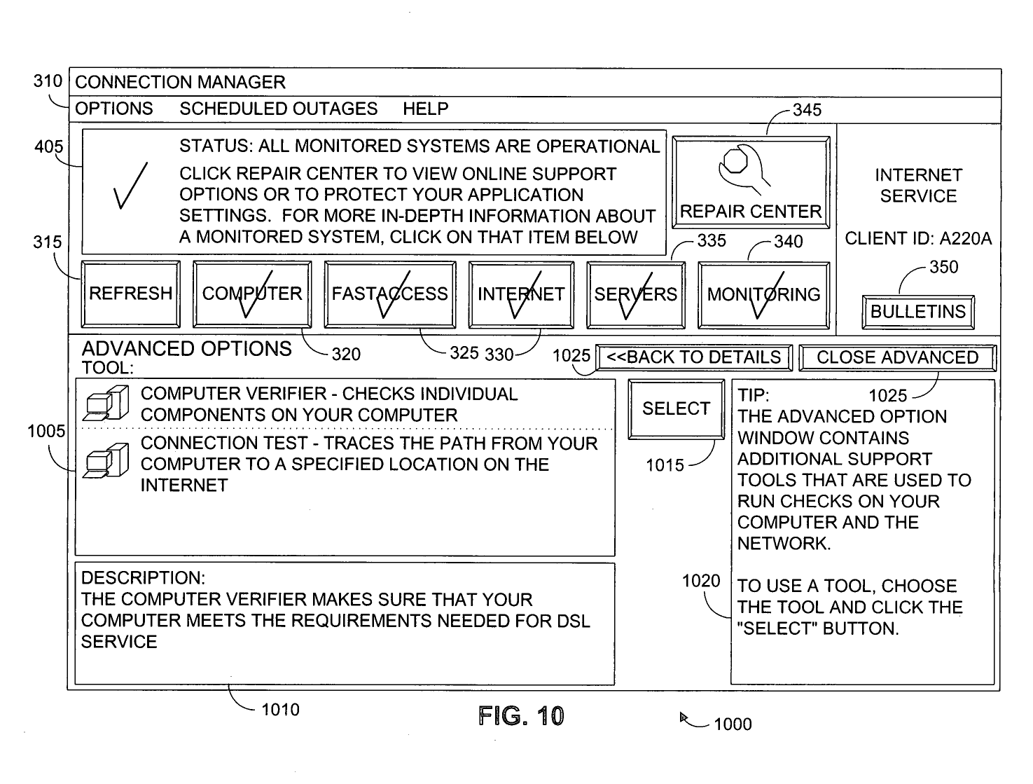

The connection manager 250 also typically includes a “Repair Center” button representation 530 and an “Advanced” button representation 535. The “Repair Center” button representation 530, when selected, requests a repair center screen representation, shown with respect to FIG. 7. The repair center screen representation typically helps users determine what sort(s) of adjustments may be helpful in resuming service. The “Advanced” button representation 535, when selected, requests an advanced options screen representation, as shown with respect to FIG. 10. The advanced options screen representation typically enables users to test their systems and connections.

Referring now to FIG. 6, shown is a sample screen shot of an embodiment, among others, of a report screen representation 600 of the connection manager 250. The report screen representation 600 typically includes a report representation 605. The report representation includes the results a number of diagnostic tests performed on the particular component for which the user requested the report be created. Moreover, the report includes a “Repair Center” button representation 610, which, when selected, provides the user with suggested repairs based upon the problem encountered by the connection manager 250.

The connection manager 250 also provides a “Send Report” button representation 615, a “<<Back” button representation 620, and a “Close Report” button representation 625. The “Send Report” button representation 615, when selected, instructs the connection manager 250 to send the report to a helpdesk. The “<<Back” button representation 620, when selected, returns to the previous screen representation. The “Close Report” button representation 625, when selected, closes the report section of the screen representation.

Referring now to FIG. 7, shown is a sample screen shot of an embodiment, among others, of a repair center screen representation 700. The repair center screen representation 700 typically includes a suggestions representation 705. The suggestions representation 705, as known in the art typically provides suggestions for possible solutions which can be performed by the user. The repair center screen representation 700 also typically includes a “Repair Utilities” section representation 710, a “Tech Support Info” section representation 715, and a “You're Connected” section representation. The “Repair Utilities” section representation 710 typically provides links to downloadable utilities/apps which help to diagnose a connection problem. The “Tech Support Info” section representation 715 typically provides links to the ISP's technical support staff. The “You're Connected” section representation 720 typically provides a link to the technical support website. The connection manager 250 also provides a “Close” button representation 725, which, when selected, will close the repair center portion of the screen representation 700.

Referring now to FIG. 8, shown is a sample screen shot of an embodiment, among others, of a “Computer Details” screen representation 800. The “Computer Details” screen representation 800 is typically accessed by selecting the “Computer” button representation 320. The “Computer Details” screen representation 800 typically includes a “Computer Details” section representation 805. The “Computer Details” section representation 805 includes a list of items on the user's system that are monitored by the connection manager 250 and a current status regarding those items.

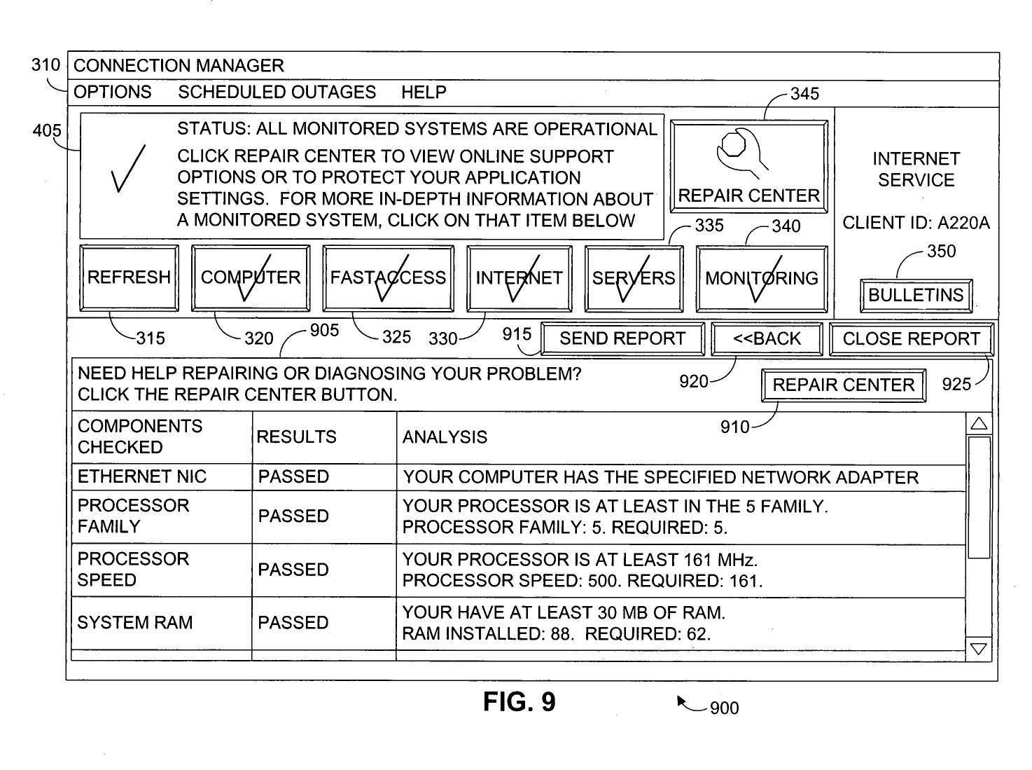

The “Computer Details” screen representation 800 typically includes a plurality of button representations which include, among others: a “Repair Center” button representation 810, an “Advanced” button representation 815, a “Report” button representation 820, and a “Close” button representation 830. The “Repair Center” button representation 810, when selected, typically retrieves a repair center screen representation, similar to the screen representation of FIG. 7. The “Advanced” button representation 815, when selected, typically retrieves an advanced options screen representation, as shown with respect to FIG. 10. The “Report” button representation 820, when selected, typically instructs the connection manager 250 to create a report of the computer details. Creating the report typically entails running diagnostics on the users computer and displaying them to the user as shown with respect to FIG. 9. The “Close” button representation 730, when selected, typically closes the computer details section of the “Computer Details” screen representation 800. The connection manager 250 also typically provides a “Tip” section representation 825 to the user. The “Tip” section representation typically includes a short explanation of the items that are displayed on the “Computer Details” screen representation 800.

Referring now to FIG. 9, shown is a sample screen shot of an embodiment, among others, of a computer report screen representation 900 of the connection manager 250. The computer report screen representation 900 typically includes a test section 905. The test section is typically a list of items related to the user's computer upon which diagnostic tests can be run, the result and a more detailed analysis of the result. The computer report screen representation 900 further includes a plurality of button representations 910-925. The plurality of button representations include, among others: a “Repair Center” button representation 910, a “Send Report” button representation 915, a “<<Back” button representation 920, and a “Close Report” button representation 925. Each of these button representations 910-925 was explained with respect to FIG. 6, and one skilled in the art should recognize that these button representations 910-925 perform similar functions respective to the current report.

Referring now to FIG. 10, shown is a sample screen shot of an embodiment, among others, of an “Advanced Options” screen representation 1000 of the connection manager 250. The “Advanced Options” screen representation 1000 typically includes a list representation 1005 including advanced diagnostic tests that can be performed on the user's computer. Typically, the “Advanced Options” screen representation also includes a description section representation 1010 which displays a description about the highlighted diagnostic test. The user would typically run a test by highlighting the test by moving a mouse pointer representation (not shown) over the test and pressing the left button, and then selecting a “Select” button representation 1015 using the mouse pointer representation. The “Advanced Options” screen representation 1000 also typically includes a “Tip” section representation 1020, which displays tips to the user regarding the “Advanced Options” screen representation 1000. The “Advanced Options” screen representation 1000 also includes a “Back to Details” button representation 1025, and a “Close Advanced” button representation 1030. The “Back to Details” button representation 1025, when selected, typically returns the user to a respective “Details” screen representation. The “Close Advanced” button representation 1030 typically closes the “Advanced Options” section of the “Advanced Options” screen representation 1000.

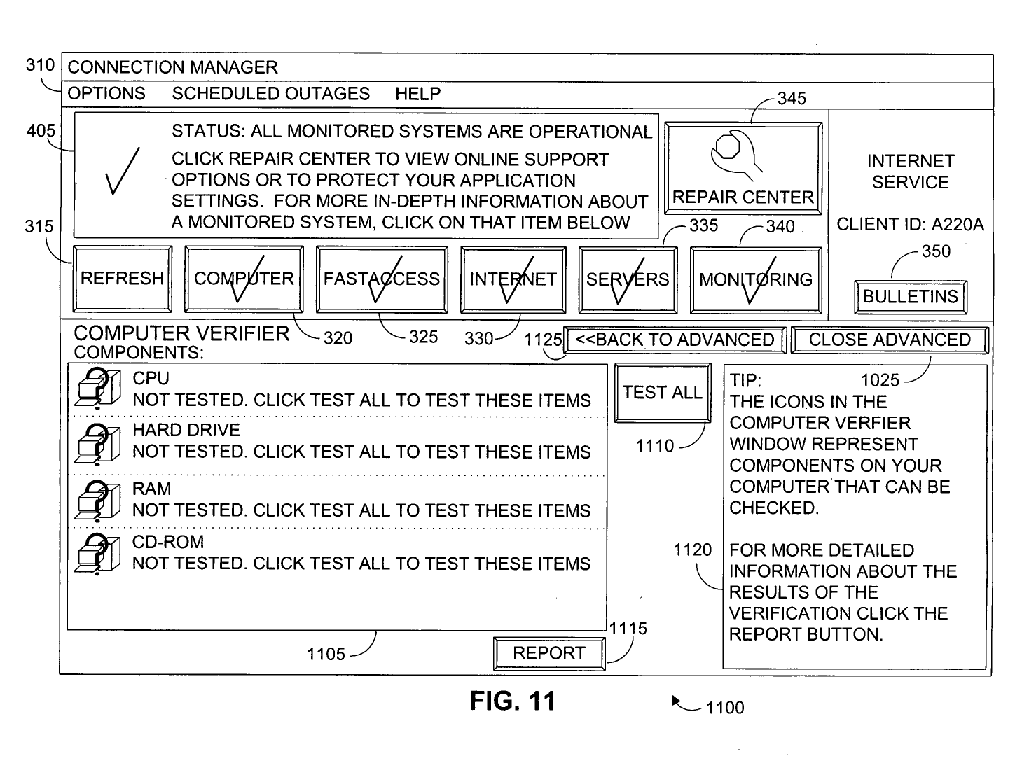

Referring now to FIG. 11, shown is a sample screen shot of an embodiment, among others, of a “Computer Verifier” test screen representation 1100 of the connection manager 250. The “Computer Verifier” test screen representation 1100 is typically reached by selecting the “Computer Verifier” test from the “Advanced Options” screen representation 1000, and typically includes a list representation 1105 including items on the users computer that can be tested. The user would typically run the tests by selecting a “Test All” button representation 1110 using the mouse pointer representation (not shown). The connection manager 250 would typically create a report regarding the tested items upon the user selecting the “Report” button representation 1115. The “Computer Verifier” test screen representation 1100 also typically includes a “Tip” section representation 1120, which displays tips to the user regarding the “Computer Verifier” test screen representation 1100. The “Computer Verifier” test screen representation 1100 also includes a “Back to Advanced” button representation 1125 that, when selected, typically returns the user to a respective “Advanced Options” screen representation.

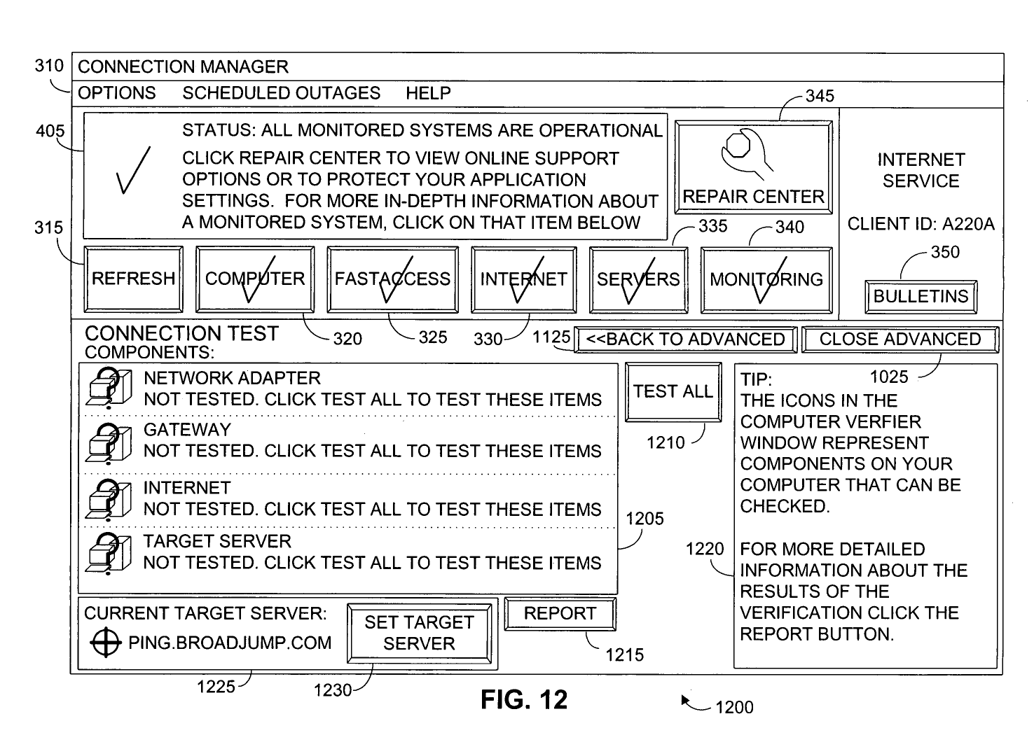

Referring now to FIG. 12, shown is a sample screen shot of an embodiment, among others, of a “Connection Test” test screen representation 1200 of the connection manager 250. The “Connection Test” test screen representation 1200 is typically reached by selecting the “Connection Test” test from the “Advanced Options” screen representation 1000, and typically includes a list representation 1205 including items in the user's connection that can be tested. The user would typically run the tests by selecting a “Test All” button representation 1210 using the mouse pointer representation (not shown). The connection manager 250 would typically create a report regarding the tested items upon the user selecting the “Report” button representation 1215. The “Connection Test” test screen representation 1200 also typically includes a “Tip” section representation 1220, which displays tips to the user regarding the “Connection Test” test screen representation 1200. The “Connection Test” test screen representation 1200 also includes a “Back to Advanced” button representation 1125 and a “Close Advanced” button representation 1025. The “Back to Advanced” button representation 1125, when selected, typically returns the user to a respective “Advanced Options” screen representation. The “Close Advanced” button representation 1030 typically closes the “Advanced Options” section of the “Advanced Options” screen representation 1000. In addition to these functions, the “Connection Test” test screen representation 1200 includes a “Current Target Server” field representation 1225. The “Current Target Server” field representation 1225 includes a “Set Target Server” button representation 1230, which, when selected, enables the user to set a new target server for the connection manager 250 to use with regard to the tests performed.

Referring now to FIG. 13, shown is a sample screen shot of an embodiment, among others, of a “FastAccess” details screen representation 1300 of the connection manager 250. In particular the screen representation 1300 typically includes “FastAccess” details status representation 1305. The status representation 1305 typically includes a list of items 1310, 1315, which the connection manager 250 is configured to track. In particular, the connection manager 250 is typically operable to track “Basic Connectivity” indicated by the status representation 1310, and a “DNS” status indicated by the “DNS” status representation 1315.

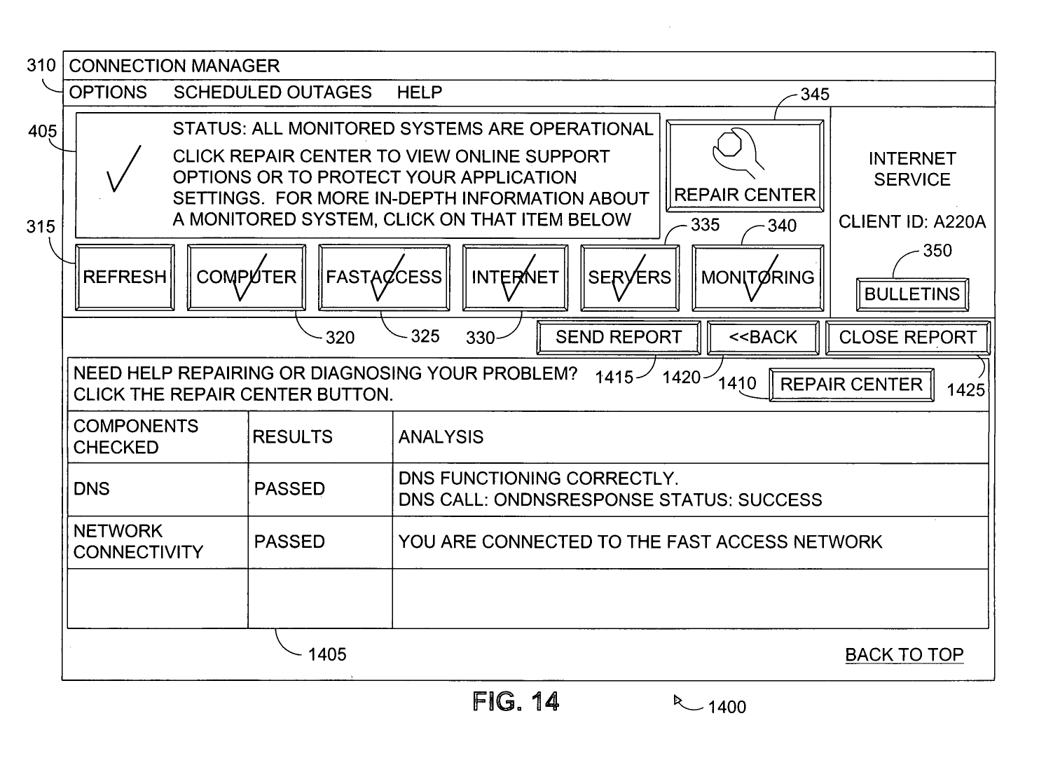

The user typically generates a report on the problem by selecting the “Report” button representation 1320. The report typically includes a number of subcomponents which will help the user to determine a cause for the problem. A sample report is shown with respect to FIG. 14. Typically the report will include details about the results of various attempts to contact machines associated with the specified activity (e.g. “Basic Connectivity”).

The connection manager 250 also typically includes a “Repair Center” button representation 1325 and an “Advanced” button representation 1330. The “Repair Center” button representation 1325, when selected, requests a repair center screen representation. The repair center screen representation typically helps users determine what sort(s) of adjustments may be helpful in resuming service. The “Advanced” button representation 1330, when selected, requests an advanced options screen representation. The advanced options screen representation typically enables users to test their systems and connections.

Referring now to FIG. 14, shown is a sample screen shot of an embodiment, among others, of a “FastAccess” report screen representation 1400 of the connection manager 250. The “FastAccess” report screen representation 1400 typically includes a test section 1405. The test section is typically a list of items related to the user's connection upon which diagnostic tests can be run, the result and a more detailed analysis of the result. The “FastAccess” screen representation 1400 further includes a plurality of button representations 1410-1425. The plurality of button representations include, among others: a “Repair Center” button representation 1410, a “Send Report” button representation 1415, a “<<Back” button representation 1420, and a “Close Report” button representation 1425. Each of these button representations 1410-1425 was explained with respect to like button representations in FIG. 6, and one skilled in the art should recognize that these button representations 1410-1425 perform similar functions respective to the current report.

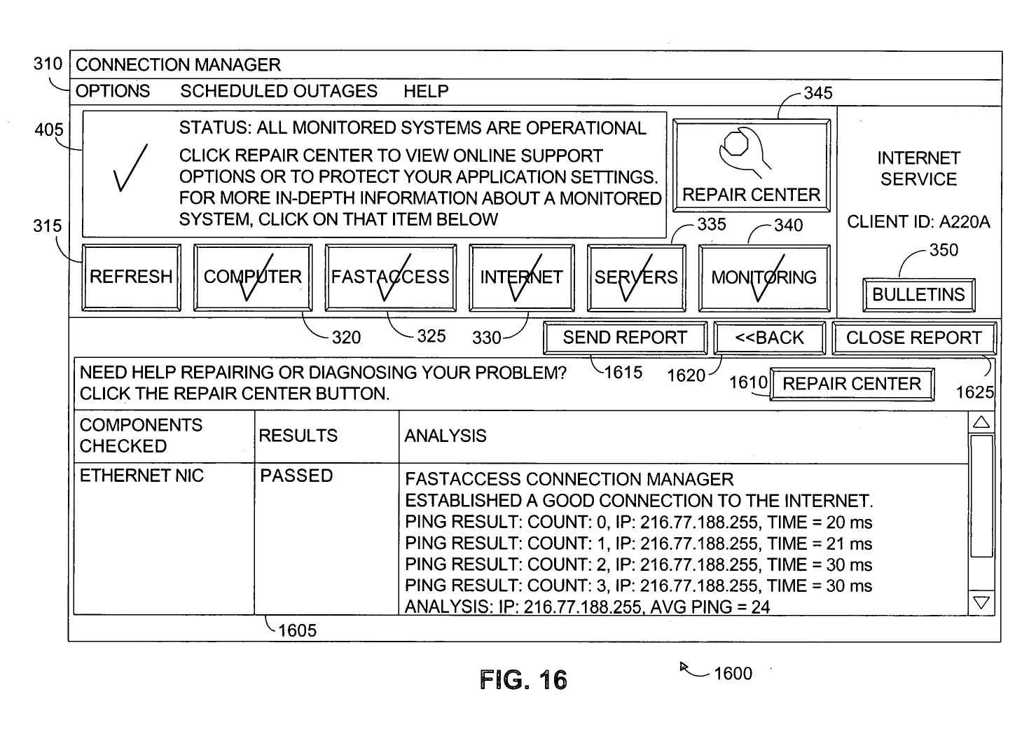

Referring now to FIG. 15, shown is a sample screen shot of an embodiment, among others, of an “Internet” details screen representation 1500 of the connection manager 250. In particular, the screen representation 1500 typically includes “Internet” details status representation 1505. The status representation 1505 typically includes a list of items 1510, which the connection manager 250 is configured to track. In particular, the connection manager 250 is typically operable to track “Internet Connectivity” indicated by the status representation 1510 The user typically generates a report on the problem by selecting the “Report” button representation 1515. The report typically includes a number of subcomponents which will help the user to determine a cause for the problem. A sample report is shown with respect to FIG. 16. Typically the report will include details about the results of various attempts to send information through the internet.

The connection manager 250 also typically includes a “Repair Center” button representation 1420 and an “Advanced” button representation 1425. The “Repair Center” button representation 1420, when selected, requests a repair center screen representation. The repair center screen representation typically helps users determine what sort(s) of adjustments may be helpful in resuming service. The “Advanced” button representation 1425, when selected, requests an advanced options screen representation. The advanced options screen representation typically enables users to test their systems and connections.

Referring now to FIG. 16, shown is a sample screen shot of an embodiment, among others, of a “Internet” report screen representation 1600 of the connection manager 250. The “Internet” report screen representation 1600 typically includes a test section 1605. The test section is typically a list of items related to the user's connection upon which diagnostic tests can be run, the result and a more detailed analysis of the result. The “Internet” screen representation 1600 further includes a plurality of button representations 1610-1625. The plurality of button representations include, among others: a “Repair Center” button representation 1610, a “Send Report” button representation 1615, a “<<Back” button representation 1620, and a “Close Report” button representation 1625. Each of these button representations 1610-1625 was explained with respect to like button representations in FIG. 6, and one skilled in the art should recognize that these button representations 1610-1625 perform similar functions respective to the current report.

One skilled in the art should recognize that there are numerous connection management tools currently available for use on computers. One such tool is the “Connection Manager 2.1” available from BellSouth, of Atlanta, Ga. It should be recognized that the specific format and configuration of the connection management tool is not critical to the present disclosure, and that a variety of connection management tools can be used in conjunction with the present disclosure in various embodiments. Thus, each of these other connection management tools is intended to be included within the scope of the present disclosure.

Process and function descriptions and blocks in flow charts can be understood as representing, in some embodiments, modules, segments, or portions of code which include one or more executable instructions for implementing specific logical functions or steps in the process, and alternate implementations are included within the scope of the preferred embodiment of the present disclosure in which functions may be executed out of order from that shown or discussed, including substantially concurrently or in reverse order, depending on the functionality involved, as would be understood by those reasonably skilled in the art of the present disclosure. In addition, such functional elements can be implemented as logic embodied in hardware, software, firmware, or a combination thereof, among others. In some embodiments involving software implementations, such software comprises an ordered listing of executable instructions for implementing logical functions and can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a computer-readable medium can be any means that can contain, store, communicate, propagate, or transport the software for use by or in connection with the instruction execution system, apparatus, or device.

It should also be emphasized that the above-described embodiments of the present disclosure are merely possible examples of implementations set forth for a clear understanding of the principles of the disclosure. Many variations and modifications may be made to the above-described embodiment(s) of the disclosure without departing substantially from the principles of the disclosure. All such modifications and variations are intended to be included herein within the scope of this disclosure and the present disclosure and protected by the following claims.

1. A modem, comprising:
a processor operable to execute code;
a memory coupled to the processor, and operable to store a connection management program; and
an input/output interface coupled to the processor, and operable to communicate data to/from a remote server and communicate data to/from a local computer, the input/output interface is further operable to provide an interface for the connection management program to the local computer.

2. The modem of claim 1, wherein the input/output interface is further operable to allow an internet service provider to load software upgrades to the memory on the modem.

3. The modem of claim 2, wherein the input/output interface is further operable to allow the internet service provider to view a plurality of diagnostics and an analysis associated with the connection management program.

4. The modem of claim 1, wherein the connection management program is embodied in a computer readable medium, and is operable to perform the steps of:
receiving a request from a user to perform a test on a connection between the computer and at least one of an internet service provider server and an internet web server;
performing a diagnostic test responsive to the request; and
providing the results of the test to the user via the computer.

5. The modem of claim 4, wherein the program step of providing the results of the test to the user via the local computer further comprises providing the results to the user in a graphical format.

6. The modem of claim 1, wherein the connection management program is operable to provide a video stream comprising a graphical user interface format to the input/output interface for transfer to the local computer.

7. The modem of claim 1, wherein the connection management program is operable to provide a plurality of information to the local computer, and the local computer includes a program operable to format the plurality of information and provide the user with a graphical user interface.

8. A method for providing internet service, comprising the steps of:
receiving a request from a user to initiate internet data service;
providing the user with a modem for internet data service, the modem comprising a connection management program operable to assist the user in setting up the modem and internet data service; and
supplying internet data service to the user.

9. The method of claim 8, wherein the modem is operable to be efficiently replaced if problems develop.

10. The method of claim 8, wherein the interface to the connection management program comprises a web browser.

11. The method of claim 8, further comprising the step of:
pushing a software upgrade to the modem.

12. The method of claim 8, further comprising the step of:
reducing the processing overhead on a computer associated with the user.

13. The method of claim 8, further comprising:
providing technical support to the user by independently retrieving diagnostics from the modem.

14. A computer readable medium residing on a modem, the computer readable medium having a program to manage a connection to an internet service provider, the program operable to perform the steps of:
establishing a connection from a computer to an internet service provider via the modem;
monitoring the connection to the internet service provider;
diagnosing a problem responsive to the monitoring step; and
providing an analysis from the modem to a computer associated with the modem.

15. The program of claim 14, further comprising the step of allowing an internet service provider to push software upgrades to the modem.

16. The program of claim 14, further comprising the step of enabling an internet service provider technician to access the analysis from the modem.

17. The program of claim 14, wherein providing an analysis comprises streaming a video signal to the computer via the connection between the modem and the computer.

18. The program of claim 14, wherein providing an analysis comprises sending raw data to the computer, the computer being operable to format the raw data for display to a user.

19. The program of claim 14, wherein providing an analysis comprises providing suggested solutions responsive to a problem discovered by the monitoring and diagnosing steps.

20. The program of claim 14, the program further comprising the step of monitoring the computer for anything that may cause problems with the computer connecting to the internet service provider.
